(19) United States
(12) Patent Application Publication
(10) Pub. No.: US 2026/0036843 A1
(43) Pub. Date: Feb. 5, 2026

(54) LIQUID CRYSTAL DISPLAY DEVICE

(71) Applicant: Sharp Display Technology Corporation, Kameyama City (JP)

(72) Inventor: Shinji SHIMADA, Kameyama City (JP)

(21) Appl. No.: 19/287,873

(22) Filed: Aug. 1, 2025

(30) Foreign Application Priority Data
Aug. 5, 2024 (JP) 2024-128983

(51) Int. Cl. G02F 1/1335; G02F 1/1343

(52) U.S. Cl. CPC G02F 1/133512; G02F 1/133514; G02F 1/134309

(57) ABSTRACT

The liquid crystal display device includes a first substrate sequentially including a support substrate, a conductive line layer, a color filter layer, a first electrode, an insulating layer, and a second electrode. The color filter layer includes color filters. Adjacent two color filters have different colors and have an overlapping portion. The first substrate includes a first light-shielding member and a second light-shielding member. The first light-shielding member overlaps the overlapping portion, and the second light-shielding member overlaps the overlapping portion and the first light-shielding member. The width of the second light-shielding member is greater than the width of the first light-shielding member. The width of one type of color filter having one of a plurality of colors is greater than the sum of the width of a space between adjacent second light-shielding members, the width of the first light-shielding member, and the width of the second light-shielding member.

### CROSS-REFERENCE TO RELATED APPLICATIONS

The present application claims priority under 35 U.S.C. § 119 to Japanese Patent Application No. 2024-128983 filed on Aug. 5, 2024, the contents of which are incorporated herein by reference in their entirety.

### BACKGROUND OF THE INVENTION

### Field of the Invention

The following disclosure relates to liquid crystal display devices.

### Description of Related Art

A liquid crystal panel, which is a main component of a liquid crystal display device, typically has a structure in which a TFT array substrate including pixel electrodes and switching elements and a color filter substrate serving as a counter substrate are bonded together with a liquid crystal layer therebetween. Such a liquid crystal panel controls the amount of light transmission by applying a voltage to the liquid crystal layer and then changing the alignment of the liquid crystal molecules in accordance with the applied voltage.

In recent years, there has been a demand for liquid crystal panels with even higher resolution (i.e., higher definition). In high-definition liquid crystal panels, each pixel has a smaller area. As the pixel definition increases, the effect of a decrease in the aperture ratio becomes more significant. To ensure the aperture ratio, therefore, the line width of a light-shielding layer (e.g., black matrix) between adjacent color filters of different colors is designed to be small. When substrates are bonded together, positional misalignment usually occurs. To prevent or reduce positional misalignment between the color filters and the pixel electrodes included in the TFT array substrate, for example, a technology for arranging color filters in the TFT array substrate, that is, a so-called color filter on array structure, can be adopted.

For example, JP 2016-014778 A discloses a liquid crystal display device having a color filter on array structure which satisfies a relation of d≤0.3w, where w represents a distance between the centers of the image signal lines that partition the pixel; and d represents a distance between an upper part of the image signal line and a lower part of the liquid crystal layer, and examines reduction of color mixing.

### BRIEF SUMMARY OF THE INVENTION

In a high-definition liquid crystal display device having a color filter on array structure, it is difficult to form light-shielding members such as a black matrix on the counter substrate due to problems with processing precision. In an oblique view from the direction along which color filters of different colors are arranged, light transmitted through adjacent color filters of different colors leaks out, causing color mixing, a phenomenon known as “color mixing in an oblique view”. This can significantly reduce color reproducibility during monochrome display.

In response to the above issues, the present invention aims to provide a liquid crystal display device which has high transmittance, can prevent or reduce the occurrence of color mixing in an oblique view, and can meet the needs for higher definition.

(1) One embodiment of the present invention is directed to a liquid crystal display device sequentially including: a first substrate; a liquid crystal layer; and a second substrate, the first substrate sequentially including a support substrate, a conductive line layer, a color filter layer, a first electrode, an insulating layer, and a second electrode disposed so as to at least partially face the first electrode with the insulating layer therebetween, the color filter layer including a plurality of color filters arranged along a first direction, each of the plurality of color filters having one of a plurality of colors, two color filters adjacent in the first direction among the plurality of color filters having different colors and having at least one overlapping portion where they overlap each other, the first substrate including at least one first light-shielding member disposed on a support substrate side relative to the color filter layer and at least one second light-shielding member disposed on a liquid crystal layer side relative to the color filter layer, the first light-shielding member overlapping at least a portion of the overlapping portion in a plan view, the second light-shielding member overlapping at least a portion of the overlapping portion and at least a portion of the first light-shielding member in a plan view, a width in the first direction of the second light-shielding member being greater than a width in the first direction of the first light-shielding member, and when the width in the first direction of the first light-shielding member is defined as Xsl₁, the width in the first direction of the second light-shielding member is defined as Xsl₂, and a width in the first direction of a space between adjacent second light-shielding members in the first direction is defined as Xp, a width in the first direction of color filters of one of the plurality of colors among the plurality of color filters being greater than the sum of Xp, Xsl₁, and Xsl₂.

(2) In an embodiment of the present invention, the liquid crystal display device includes the structure (1), and the first light-shielding member is a conductive line included in the conductive line layer.

(3) In an embodiment of the present invention, the liquid crystal display device includes the structure (1), and the first light-shielding member is disposed between the support substrate and the conductive line layer.

(4) In an embodiment of the present invention, the liquid crystal display device includes the structure (3), and the conductive line layer includes a conductive line overlapping at least a portion of the overlapping portion and at least a portion of the first light-shielding member in a plan view.

(5) In an embodiment of the present invention, the liquid crystal display device includes any one of the structures (1) to (4), each of the color filters extends along a second direction intersecting the first direction, and the overlapping portion, the first light-shielding member, and the second light-shielding member also extend along the second direction.

(6) In an embodiment of the present invention, the liquid crystal display device includes any one of the structures (1) to (5), and the overlapping portion, the first light-shielding member, and the second light-shielding member each have a width in the first direction substantially constant in the second direction.

(7) In an embodiment of the present invention, the liquid crystal display device includes any one of the structures (1) to (6), the first direction is defined as a direction from a first side to a second side of the liquid crystal display device, and in a case where: an edge of the overlapping portion closer to the first side is defined as a 1st edge, an edge of the overlapping portion closer to the second side is defined as a 2nd edge, an edge of the first light-shielding member closer to the first side is defined as a 3rd edge, an edge of the first light-shielding member closer to the second side is defined as a 4th edge, an edge of the second light-shielding member closer to the first side is defined as a 5th edge, and an edge of the second light-shielding member closer to the second side is defined as a 6th edge, the 5th edge, the 1st edge, the 3rd edge, the 4th edge, the 2nd edge, and the 6th edge are arranged sequentially from the first side to the second side.

(8) In an embodiment of the present invention, the liquid crystal display device includes any one of the structures (1) to (7), in the color filter layer, the at least one overlapping portion includes a plurality of overlapping portions extending along a second direction and arranged along the first direction, the second direction intersecting the first direction, in the first substrate, the at least one first light-shielding member includes a plurality of first light-shielding members extending along the second direction and arranged along the first direction, and the at least one second light-shielding member includes a plurality of second light-shielding members extending along the second direction and arranged along the first direction, and each of the overlapping portions overlaps at least a portion of a corresponding first light-shielding member among the plurality of first light-shielding members and at least a portion of a corresponding second light-shielding member among the plurality of second light-shielding members in a plan view.

(9) In an embodiment of the present invention, the liquid crystal display device includes any one of the structures (1) to (8), and a width in the first direction of each of the plurality of color filters is greater than the sum of Xp, Xsl₁, and Xsl₂.

(10) In an embodiment of the present invention, the liquid crystal display device includes any one of the structures (1) to (8), and a width in the first direction of each of the plurality of color filters is smaller than the sum of Xp and twice Xsl₂.

(11) In an embodiment of the present invention, the liquid crystal display device includes any one of the structures (1) to (10), and the second electrode includes an aperture at least partially overlapping the first electrode in a plan view.

(12) In an embodiment of the present invention, the liquid crystal display device includes any one of the structures (1) to (11), the first substrate includes a nonlinear element electrically connected to a conductive line included in the conductive line layer, the first electrode is a pixel electrode and the second electrode is a common electrode, and the pixel electrode is electrically connected to the nonlinear element via a through hole penetrating at least the color filter layer.

(13) In an embodiment of the present invention, the liquid crystal display device includes any one of the structures (1) to (11), the first substrate includes a nonlinear element electrically connected to a conductive line included in the conductive line layer, the first electrode is a common electrode and the second electrode is a pixel electrode, and the pixel electrode is electrically connected to the nonlinear element via a through hole penetrating at least the insulating layer and the color filter layer.

(14) In an embodiment of the present invention, the liquid crystal display device includes any one of the structures (1) to (13), and the second substrate does not include a light-shielding member at a position facing the overlapping portion in a display region where an image is displayed.

(15) In an embodiment of the present invention, the liquid crystal display device includes any one of the structures (1) to (14) and further includes a first polarizing plate on a surface of the first substrate remote from the liquid crystal layer and a second polarizing plate on a surface of the second substrate remote from the liquid crystal layer, and at least one of the first polarizing plate or the second polarizing plate has an absorption peak in a wavelength range of 580 nm or more and 590 nm or less.

The present invention can provide a liquid crystal display device which has high transmittance, can prevent or reduce the occurrence of color mixing in an oblique view, and can meet the needs for higher definition.

### BRIEF DESCRIPTION OF THE DRAWINGS

FIG. 1 is a schematic cross-sectional view of an example of a liquid crystal display device of Embodiment 1.

FIG. 2 is a schematic plan view of an example of the liquid crystal display device of Embodiment 1.

FIG. 3 is a schematic cross-sectional view of a first substrate 10 in FIG. 1.

FIG. 4 is a schematic cross-sectional view of an example of a liquid crystal display device of Embodiment 2.

### DETAILED DESCRIPTION OF THE INVENTION

### Definition of Terms

The “viewing surface side” herein means the side closer to the screen (display surface) of the liquid crystal display device. The “back surface side” herein means the side farther from the screen (display surface) of the liquid crystal display device. The “plan view” refers to the view from the viewing surface side.

The “substantially parallel” means that the angle (absolute value) between the two falls within the range of 0°±10°, and the angle preferably falls within the range of 0°±5°, more preferably 0° (i.e., parallel in the narrow sense). The “substantially orthogonal (or substantially perpendicular)” means that the angle (absolute value) between the two falls within the range of 90°±10°, and the angle preferably falls within the range of 90°±5°, more preferably 90° (i.e., orthogonal or perpendicular in the narrow sense).

Hereinafter, embodiments of a liquid crystal display device of the present invention are described. The present invention is not limited to the contents of the following embodiments. The design may be modified as appropriate within the range satisfying the configuration of the present invention.

### Embodiment 1

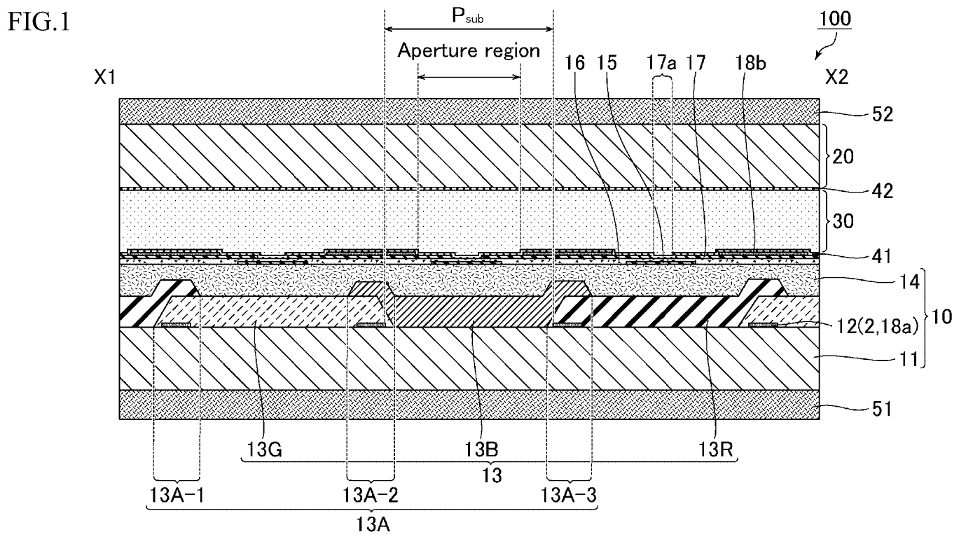

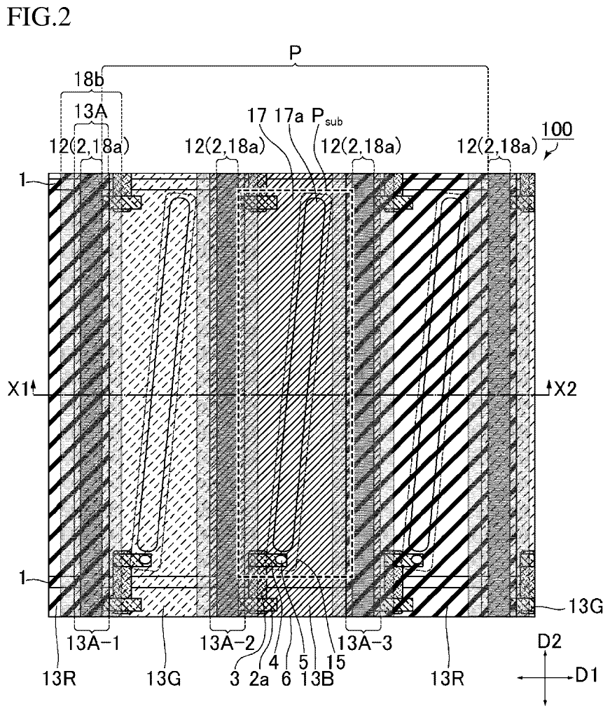

FIG. 1 is a schematic cross-sectional view of an example of a liquid crystal display device of Embodiment 1. FIG. 2 is a schematic plan view of an example of the liquid crystal display device of Embodiment 1. FIG. 1 is also a cross-sectional view that is taken along the line X1-X2 in FIG. 2 (cross-sectional view taken along the line X1-X2).

A liquid crystal display device 100 of Embodiment 1 sequentially includes a first substrate 10, a liquid crystal layer 30, and a second substrate 20. In other words, the liquid crystal layer 30 is held between the first substrate 10 and the second substrate 20 facing each other. For example, the first substrate 10, the liquid crystal layer 30, and the second substrate 20 are disposed sequentially from the back surface side to the viewing surface side. The liquid crystal layer 30 is usually sealed between the first substrate 10 and the second substrate 20 by a sealant (not shown).

The first substrate 10 sequentially includes a support substrate 11, a conductive line layer 12, a color filter layer 13, a first electrode 15, an insulating layer 16, and a second electrode 17 disposed so as to at least partially face the first electrode 15 with the insulating layer 16 therebetween. A flattening film 14 may be disposed between the color filter layer 13 and the first electrode 15. The liquid crystal display device 100 of the present embodiment is a liquid crystal display device having a color filter on array structure in which the color filter layer is included not in the counter substrate but in the TFT substrate including layers such as the conductive line layer 12. The liquid crystal display device having a color filter on array structure does not require consideration of the bonding accuracy between the first substrate 10 and the second substrate 20, and is therefore particularly suitable for use as a liquid crystal display device with a high resolution of 1000 ppi or higher.

The first substrate 10 includes subpixels Psub arranged in a matrix pattern along the row direction and the column direction (see FIG. 2). Specifically, the first substrate 10 includes the support substrate 11, gate lines (also called scanning lines) 1 on the support substrate 11, source lines (also called signal lines) 2 intersecting the gate lines 1, and switching elements (nonlinear elements 6). The region including subpixels is a display region. The support substrate 11 is preferably transparent and insulating. Examples of the support substrate 11 include a glass substrate and a plastic substrate.

As shown in FIG. 2, the gate lines 1 are substantially parallel to one another along the row direction. The source lines 2 are substantially parallel to one another along the column direction so as to intersect the respective gate lines 1 substantially perpendicularly. The source lines 2 and the gate lines 1 as a whole form a matrix pattern (grid pattern) to define a subpixel. A substantially rectangular region surrounded by two adjacent gate lines 1 and two adjacent source lines 2 defines a subpixel. In other words, a subpixel is defined by a region surrounded by two adjacent gate lines 1 and two adjacent source lines 2. When the color filter layer 13, which is described later, includes red color filters, green color filters, and blue color filters, one pixel P includes a subpixel overlapping a red color filter, a subpixel overlapping a green color filter, and a subpixel overlapping a blue color filter. Herein, the resolution of a liquid crystal display device refers to the number of pixels per inch.

The conductive line layer 12 is a conductive line group disposed between the support substrate 11 and the color filter layer 13, and includes conductive lines involved in driving the nonlinear elements 6, which are described later. Examples of the conductive lines included in the conductive line layer 12 include the gate lines 1 and the source lines 2. The conductive lines included in the conductive line layer 12 do not have to be arranged in the same layer, and may be arranged with an insulating layer or another layer therebetween. For example, the gate lines 1 and the source lines 2 are arranged with a gate insulating layer (not shown) therebetween. The conductive lines included in the conductive line layer 12 preferably extend in a first direction D1 or a second direction D2, and may be connected to drivers such as gate drivers or source drivers.

Examples of the gate lines 1 and the source lines 2 include metal films containing a metal such as titanium (Ti), molybdenum (Mo), aluminum (Al), or molybdenum tungsten (MoW) and multilayer films of any of these.

The first substrate 10 includes the nonlinear elements 6 electrically connected to the conductive lines included in the conductive line layer 12. Each nonlinear element 6 is a switching element that controls the gray scale of a subpixel, and examples thereof include a thin film transistor (TFT) element. The nonlinear element 6 is disposed in a subpixel at the intersection of the corresponding source line 2 and the corresponding gate line 1. For example, as shown in FIG. 2, the nonlinear element 6 includes a portion of the gate line 1 as a gate electrode, a branch 2a of the source line 2 as a source electrode, a semiconductor layer 3, and a drain electrode 4. The drain electrode 4 is electrically connected to the first electrode 15 or the second electrode 17 via a through hole 5.

The first electrode 15, the second electrode 17, and the drain electrode 4 are preferably transparent electrodes. The transparent electrodes are preferably formed from a transparent conductive material such as indium tin oxide (ITO), indium zinc oxide (IZO), zinc oxide (ZnO), or stannous oxide (SnO), or an alloy of any of these, for example.

The flattening film 14 flattens the surface of the color filter layer 13 on the liquid crystal layer 30 side, and is preferably transparent. Examples thereof include organic films such as a film of acrylic resin, polyimide resin, or novolac resin. The insulating layer 16 insulates the first electrode 15 from the second electrode 17, and is preferably transparent. Examples thereof include inorganic films such as a film of silicon nitride or silicon oxide and multilayer films of any of these.

The first electrode 15 may function as a pixel electrode, and the second electrode 17 may function as a common electrode. In this case, the pixel electrode (first electrode 15) is electrically connected to the drain electrode 4 of the corresponding nonlinear element 6 via the corresponding through hole 5 that penetrates at least the color filter layer 13. When the flattening film 14 is disposed between the color filter layer 13 and the first electrode 15, the through hole 5 penetrates the flattening film 14 and the color filter layer 13. When the first electrode 15 functions as a pixel electrode, the first electrode 15 is disposed in each subpixel, and when the semiconductor layer 3 is energized and the corresponding nonlinear element 6 is turned on, a driving voltage corresponding to the source signal input from the corresponding source line 2 is applied to the first electrode 15. A common potential that serves as a reference for the drive voltage is applied to the second electrode 17. The second electrode 17 may be divided for each subpixel or may extend across a plurality of subpixels. To prevent or reduce positional and electrical interference between the through hole 5 and the second light-shielding member 18b and to facilitate the design, the first electrode 15 preferably functions as a pixel electrode, and the second electrode 17 preferably function as a common electrode.

The first electrode 15 may function as a common electrode, and the second electrode 17 may function as a pixel electrode. In this case, the pixel electrode (second electrode 17) is electrically connected to the drain electrode 4 of the corresponding nonlinear element 6 via a through hole (not shown) that penetrates at least the insulating layer 16 and the color filter layer 13. When the flattening film 14 is disposed between the color filter layer 13 and the first electrode 15, the through hole penetrates the insulating layer 16, the flattening film 14, and the color filter layer 13. When the first electrode 15 functions as a common electrode, the first electrode 15 may be disposed in each subpixel, but for example, a plurality of first electrodes 15 disposed corresponding to each of a plurality of subpixels are electrically connected to each other and a common potential is applied thereto. When the second electrode 17 functions as a pixel electrode, the second electrode 17 is disposed in each subpixel, and when the semiconductor layer 3 is energized and the corresponding nonlinear element 6 is turned on, a driving voltage is applied to the second electrode 17. A common potential is applied to the first electrode 15.

The second electrode 17 includes an aperture 17a at least partially overlapping the corresponding first electrode 15 in a plan view. The aperture 17a may entirely overlap the first electrode 15 in a plan view, or may have both a portion that overlaps the first electrode 15 and a portion that does not overlap the first electrode 15. In other words, the liquid crystal display device 100 is preferably a fringe field switching (FFS) mode liquid crystal display device. When a common potential is applied to either the second electrode 17 or the first electrode 15 and a drive voltage is applied to the other, a fringe electric field generates between an edge of the aperture 17a and the first electrode 15, and the alignment of the liquid crystal molecules in the liquid crystal layer 30 changes, thereby controlling the amount of light transmission.

The color filter layer 13 includes a plurality of color filters arranged along the first direction D1 in a plan view, each of the plurality of color filters having one of a plurality of colors. The first direction D1 is the direction along which the plurality of color filters are arranged in a plan view, and is parallel to the row direction in the example of FIG. 2. The plurality of colors preferably include red, green, and blue. FIG. 2 illustrates an example in which the color filter layer includes a red color filter 13R, a green color filter 13G, and a blue color filter 13B. The red color filter 13R, the green color filter 13G, and the blue color filter 13B are arranged along the first direction D1.

Two color filters adjacent in the first direction D1 among the plurality of color filters have different colors and have an overlapping portion 13A where they overlap each other. The transmittance of light passing through the overlapping portion of the color filters is greatly reduced due to the difference in the transmission spectrum of each color. Therefore, providing an overlapping portion can reduce the likelihood of the perception of color mixing by the user.

As shown in FIG. 2, the red color filter 13R and the green color filter 13G adjacent to each other in the first direction D1 have an overlapping portion 13A-1 where they overlap each other. The green color filter 13G and the blue color filter 13B adjacent to each other in the first direction D1 have an overlapping portion 13A-2 where they overlap each other. The blue color filter 13B and the red color filter 13R adjacent to each other in the first direction D1 have an overlapping portion 13A-3 where they overlap each other. Herein, unless there is a particular need to distinguish the colors of the overlapping portions, the overlapping portions 13A-1, 13A-2, and 13A-3 are collectively referred to as the overlapping portion 13A.

The width in the first direction D1 of the overlapping portion 13A is, for example, preferably 1.5 μm or more and 4 μm or less, more preferably 2 μm or more and 3 μm or less. The widths of the overlapping portions 13A-1, 13A-2, and 13A-3 may be the same as or different from each other.

A portion of a color filter in the aperture region of a subpixel preferably has a thickness T₁ of, for example, 1 μm or more and 2.5 μm or less, more preferably 1.5 μm or more and 2 μm or less. In the overlapping portion 13A, the thickness T₂ of a portion of the color filter overlapping the adjacent color filter is preferably about half the thickness T₁, and is preferably, for example, 0.5 μm or more and 1.5 μm or less, more preferably 0.75 μm or more and 1 μm or less. Herein, the aperture region of a subpixel refers to a region of the subpixel that can transmit light irradiated from the back surface side to the front surface side, and refers to a region in which a first light-shielding member 18a, a second light-shielding member 18b, and a different light-shielding member are not disposed in a plan view.

The first substrate 10 includes first light-shielding members 18a disposed on a support substrate 11 side relative to the color filter layer 13, and second light-shielding members 18b disposed on a liquid crystal layer 30 side relative to the color filter layer 13 (in the present embodiment, closer to the liquid crystal layer 30 than the flattening film 14). In Embodiment 1, the first light-shielding members 18a are conductive lines included in the conductive line layer 12 (source lines 2 in FIG. 1). Providing the first light-shielding members 18a and the second light-shielding members 18b can prevent or reduce the occurrence of color mixing in an oblique view without providing light-shielding members such as a black matrix on the second substrate 20. When the second substrate 20 includes no light-shielding members, there has been a problem that color mixing in an oblique view occurs in an oblique view from the direction along which the color filters of different colors are arranged. The inventors have studied on this problem and found that although light-shielding between color filters of different colors can also be achieved by metal conductive lines such as gate lines and source lines located in a layer below the color filter layer 13 (the support substrate 11 side), it is difficult to increase the width of these conductive lines in particular in a high-definition liquid crystal display device because of the need to prevent or reduce an increase in wiring capacitance and to ensure the aperture areas of pixels. Providing the second light-shielding members 18b in a layer above the color filter layer 13 (particularly, a layer above the flattening film 14 formed on the color filter layer 13) (the liquid crystal layer 30 side) can prevent or reduce color mixing in an oblique view while the aperture ratio is ensured, even in a high-definition liquid crystal display device. In addition, in Embodiment 1, the conductive lines (the source lines 2 in FIG. 1) included in the conductive line layer 12 also serve as the first light-shielding members 18a, thereby simplifying the structure and reducing the production cost.

The second light-shielding members 18b are preferably made of a light-shielding metal, and examples thereof include metal films containing a metal such as titanium (Ti), molybdenum (Mo), aluminum (Al), or molybdenum tungsten (MoW) and multilayer films of any of these. In order to form the second light-shielding members 18b with a small thickness, they are preferably made of metal.

Each of the second light-shielding members 18b may be in contact with the corresponding second electrode 17, or an insulating layer may be disposed between the second light-shielding member 18b and the second electrode 17. When the second light-shielding member 18b is formed so as to be in contact with the second electrode 17, the number of production steps can be reduced.

Each of the first light-shielding member 18a overlaps at least a portion of the corresponding overlapping portion 13A of color filters in a plan view. As described above, providing an overlapping portion can reduce the likelihood of the perception of color mixing by the user. Still, when color filters are formed using a general photoresist, it is difficult to form a thick overlapping portion. To make the overlapping portion 13A thicker than that formed using a resist only, the first light-shielding member 18a may be disposed overlapping at least a portion of the overlapping portion 13A of the color filters. Thereby, color mixing in an oblique view can be prevented or reduced.

As shown in FIG. 2, each of the second light-shielding members 18b overlaps at least a portion of the corresponding overlapping portion 13A in a plan view. Preferably, the second light-shielding member 18b preferably overlaps at least a portion of the overlapping portion 13A-1 where the red and green color filters overlap each other. The reason for this is as follows: a blue color filter generally has low transmittance and luminosity, and therefore light transmitted through a blue color filter is unlikely to be perceived as a mixed color by the observer, while red and green color filters have higher transmittance and luminosity than a blue color filter, and therefore light transmitted through both red and green color filters, as a result of parallax, is likely to be perceived as a mixed color by the observer. To further prevent or reduce color mixing in an oblique view, the respective second light-shielding members 18b more preferably overlap at least a portion of the overlapping portion 13A-1, at least a portion of the overlapping portion 13A-2 where the green and blue color filters overlap each other, and at least a portion of the overlapping portion 13A-3 where the blue and red color filters overlap each other.

Each of the second light-shielding members 18b overlaps at least a portion of the corresponding first light-shielding member 18a in a plan view. When the width in the first direction D1 of the first light-shielding member 18a is defined as Xsl₁ and the width in the first direction D1 of the second light-shielding member 18b is defined as Xsl₂, Xsl₂ is greater than Xsl₁. In Embodiment 1, increasing the width of the second light-shielding member 18b, which is disposed closer to the viewing surface side than the first light-shielding member 18a, can prevent or reduce an increase in wiring capacitance, can ensure the aperture ratio of the corresponding pixel, and can prevent or reduce color mixing in an oblique view. Preferably, the first light-shielding member 18a is covered by the second light-shielding member 18b in a plan view.

For example, in a liquid crystal display device having a resolution of about 1200 ppi and including subpixels each having a width of 7 μm, Xsl₂ is preferably, for example, 1 μm or more and 4 μm or less, more preferably 2 μm or more and 2.5 μm or less. Xsl₁ is, for example, preferably 1 μm or more and 3 μm or less, more preferably 1.5 μm or more and 2 μm or less.

To obtain light-shielding properties, the first light-shielding member 18a and the second light-shielding member 18b each preferably have a thickness of 20 nm or more, and to reduce the level difference, the thickness of the first light-shielding member 18b is preferably 200 nm or less.

The color filters extend along a second direction D2 intersecting the first direction D1 in a plan view. The second direction D2 is a direction along which the color filters extend in a plan view, and is parallel to the column direction in the example in FIG. 2. The overlapping portions 13A, the first light-shielding members 18a, and the second light-shielding members 18b also preferably extend along the second direction D2. The angle at which the first direction D1 and the second direction D2 intersect is preferably equal to or more than 60° and equal to or less than 90°. The first direction D1 and the second direction D2 may be substantially orthogonal to each other, and the first direction D1 may be the extension direction of the gate lines 1 (the row direction), and the second direction D2 may be the extension direction of the source lines 2 (the column direction).

Preferably, the overlapping portions 13A, the first light-shielding members 18a, and the second light-shielding members 18b each have a width in the first direction D1 substantially constant in the second direction D2. The overlapping portions 13A in the present embodiment each extend with a constant width along the second direction D2. Each of the first light-shielding members 18a and the second light-shielding members 18b also extends with a constant width along the second direction D2, and overlaps at least a portion of the corresponding overlapping portion 13A.

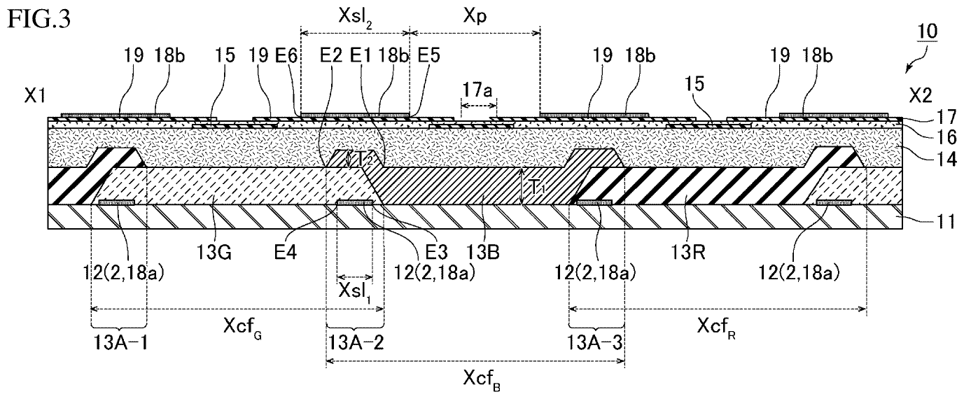

FIG. 3 is a schematic cross-sectional view of the first substrate 10 in FIG. 1. The width in the first direction of a space between adjacent two of the second light-shielding members 18b in the first direction D1 is defined as Xp. The width in the first direction D1 of color filters of one of the plurality of colors among the plurality of color filters is greater than the sum of Xp, Xsl₁, and Xsl₂. This enables significant prevention or reduction of color mixing in an oblique view without decreasing the aperture ratio of the pixels.

Xsl₁ is the width of a single first light-shielding member 18a, and Xsl₂ is the width of a single second light-shielding member 18b. Preferably, the width in the first direction D1 of each of the plurality of color filters is preferably greater than the sum of Xp, Xsl₁, and Xsl₂.

Xp is the width in the first direction D1 of the aperture region through which light passes from the back surface side of the first substrate 10 to the viewing surface side. Xp is, for example, preferably 3 μm or more and 6 μm or less, more preferably 4 μm or more and 5 μm or less.

The width in the first direction D1 of color filters of one of the plurality of colors is, for example, preferably 7 μm or more and 11 μm or less, more preferably 8 μm or more and 9 μm or less.

An edge of each of the overlapping portions 13A closer to a first side of the liquid crystal display device (e.g., the right side of the liquid crystal display device) is defined as a 1 st edge E1, where the first direction D1 is defined as a direction from the first side to a second side of the liquid crystal display device, and an edge of the overlapping portion 13A closer to the second side (e.g., the left side of the liquid crystal display device) is defined as a 2nd edge E2. An edge of each of the first light-shielding members 18a closer to the first side is defined as a 3rd edge E3, and an edge of the first light-shielding member 18a closer to the second side is defined as a 4th edge E4. An edge of each of the second light-shielding members 18b closer to the first side is defined as a 5th edge E5, and an edge of the second light-shielding member 18b closer to the second side is defined as a 6th edge E6. Preferably, the 5th edge E5, the 1st edge E1, the 3rd edge E3, the 4th edge E4, the 2nd edge E2, and the 6th edge E6 are arranged sequentially from the first side (e.g., the right side) to the second side (e.g., the left side) of the liquid crystal display device.

Preferably, the width in the first direction D1 of the first light-shielding member 18a is the greatest, followed by the width in the first direction D1 of the overlapping portion 13A, and then the width in the first direction D1 of the second light-shielding member 18b. Preferably, the first light-shielding member 18a is covered by the corresponding overlapping portion 13A and the corresponding second light-shielding member 18b in a plan view, and the overlapping portion 13A is covered by the second light-shielding member 18b in a plan view.

The color filter layer 13 includes the overlapping portions 13A, and the first substrate 10 includes the first light-shielding members 18a and the second light-shielding members 18b. The overlapping portions 13A extend along the second direction D2. The overlapping portions 13A are arranged along the first direction D1. The first light-shielding members 18a extend along the second direction D2. The first light-shielding members 18a are arranged along the first direction D1. The second light-shielding members 18b extend along the second direction D2. The second-shielding members 18b are arranged along the first direction D1.

Preferably, each of the overlapping portions 13A overlaps at least a portion of the corresponding first light-shielding member 18a among the plurality of first light-shielding members 18a and at least a portion of the corresponding second light-shielding member among the plurality of second light-shielding members in a plan view.

The corresponding first light-shielding member 18a refers to the first light-shielding member 18a overlapping at least a portion of one of the overlapping portions 13A in a plan view, and the corresponding second light-shielding member refers to the second light-shielding member 18b overlapping at least a portion of the one of the overlapping portions 13A in a plan view. For example, preferably, the corresponding first light-shielding member 18a and second light-shielding member 18b overlapping the overlapping portion 13A-1 where the red color filter 13R and the green color filter 13G overlap each other at least partially overlap each other in a plan view. More preferably, the first light-shielding member 18a entirely overlaps the second light-shielding member 18b in a plan view. In other words, the first light-shielding member 18a is more preferably covered by the second light-shielding member 18b in a plan view.

Preferably, the width in the first direction D1 of each of the plurality of color filters is smaller than the sum of Xp and twice Xsl₂ (Xp+Xsl₂×2). This enables more ensuring the aperture ratio and effective prevention or reduction of color mixing in an oblique view.

Examples of the second substrate 20 include a glass substrate and a plastic substrate. Preferably, the second substrate 20 does not include conductive lines, electrodes, and the like. Furthermore, preferably, the second substrate 20 does not include light-shielding members at positions facing the overlapping portions 13A in a display region where an image is displayed. Examples of the light-shielding members include a black matrix made of black resin and a light-shielding metal conductive line. Such a second substrate 20 is preferred in a liquid crystal display device having a color filter on array structure, particularly in a high resolution liquid crystal display device, in which the accuracy of bonding the first substrate 10 and the second substrate 20 is important as described above.

The second substrate 20 may include light-shielding members that extend in a direction intersecting the extension direction of the overlapping portions 13A in a display region. This enables prevention or reduction of light leakage from adjacent pixels viewed in the vertical direction. For example, when the overlapping portions 13A extend along the second direction D2, the second substrate 20 may include light-shielding members extending along the first direction. Specifically, when the overlapping portions 13A are formed along the source lines 2, a light-shielding member may be disposed at the position where each of the overlapping portions 13A overlaps the corresponding gate line 1.

The liquid crystal layer 30 includes liquid crystal molecules. The liquid crystal molecules are preferably a nematic liquid crystal material that exhibits nematic liquid crystallinity within a certain temperature range. The liquid crystal molecules may have positive or negative anisotropy of dielectric constant. When the liquid crystal display device 100 is an FFS mode liquid crystal display device, the liquid crystal molecules preferably have positive anisotropy of dielectric constant.

Although not shown, the liquid crystal display device 100 may have spacers that maintain the thickness of the liquid crystal layer 30. The spacers may be photospacers made of a photosensitive resin, and may be formed on the second substrate 20, or may be formed on both the first substrate 10 and the second substrate 20.

Alignment films 41 and 42 may be disposed between the first substrate 10 and the liquid crystal layer 30 and between the second substrate 20 and the liquid crystal layer 30, respectively. The alignment films 41 and 42 are preferably horizontal alignment films that align, when no voltage is applied to the liquid crystal layer 30, the liquid crystal molecules substantially parallel to the surfaces of the first substrate 10 and the second substrate 20 each facing the liquid crystal layer 30. The phrase “when no voltage is applied” also encompasses cases where a voltage lower than the threshold voltage of the liquid crystal molecules is applied to the liquid crystal layer 30.

The liquid crystal display device 100 further includes a first polarizing plate 51 on the surface of the first substrate 10 remote from the liquid crystal layer 30 and a second polarizing plate 52 on the surface of the second substrate 20 remote from the liquid crystal layer 30.

The first polarizing plate 51 and the second polarizing plate 52 are preferably linearly polarizing plates that convert the incident light into linearly polarized light. The linearly polarizing plates may be absorptive linearly polarizing plates each having a transmission axis that transmits light in a specific polarization direction and an absorption axis that is substantially orthogonal to the transmission axis. The first polarizing plate 51 and the second polarizing plate 52 are arranged in crossed Nicols such that the polarization axes thereof are substantially orthogonal to each other.

The linearly polarizing plates may each include a pair of protective films and a polarizing film containing dichroic molecules held therebetween.

An example of the polarizing film containing dichroic molecules is a polyvinyl alcohol (PVA) film that has been subjected to a dyeing treatment with iodine and a stretching treatment (for example, uniaxial stretching).

The protective films may be films commonly used in the field of linearly polarizing plates, and examples thereof include cellulose-based resin films such as a triacetyl cellulose (TAC) film and resin films such as polyester-based, polyvinyl alcohol-based, polycarbonate-based, polyamide-based, polyimide-based, polyethersulfone-based, polysulfone-based, polystyrene-based, polynorbornene-based, polyolefin-based, (meth)acrylic-based, and acetate-based films.

Preferably, at least one of the first polarizing plate 51 or the second polarizing plate 52 has an absorption peak in a wavelength range of 580 nm or more and 590 nm or less. This enables improvement of the color reproducibility of the liquid crystal display device 100 and further prevention or reduction of color mixing in an oblique view. As described above, light transmitted through both red and green color filters, as a result of parallax, is likely to be perceived as a mixed color by the observer. The wavelength of light transmitted through the overlapping portion where the red and green color filters overlap each other is about 580 nm to 590 nm. Thus, use of polarizing plates having an absorption peak in the wavelength range of 580 nm or more and 590 nm or less enables effective improvement of color reproducibility and prevention or reduction of color mixing in an oblique view.

In each of the first polarizing plate 51 and the second polarizing plate 52, the polarizing film is bonded between the pair of protective films with adhesive layers. The adhesive layers bonding the polarizing film to the protective films may contain a dye having an absorption peak in the wavelength range of 580 nm or more and 590 nm or less. The first substrate 10 and the first polarizing plate 51 may be bonded to each other with an adhesive layer, and the second substrate 20 and the second polarizing plate 52 may be bonded to each other with an adhesive layer. These adhesive layers may contain the dye. Any of the adhesive layers in the first polarizing plate 51, the adhesive layer between the first polarizing plate 51 and the first substrate 10, the adhesive layers in the second polarizing plate 52, or the adhesive layer between the second polarizing plate 52 and the first substrate 10 may contain the dye. When the effect of light scattering or diffraction occurs due to conductive lines or the like, the adhesive layers in the first polarizing plate 51 or the adhesive layer between the first polarizing plate 51 and the first substrate 10 preferably contain the dye.

Examples of the dye include phthalocyanine dyes. A specific example of the dye is a specific wavelength absorbing dye available from Yamamoto Chemicals, Inc.

The liquid crystal display device 100 may include a backlight unit on the back surface side of the first substrate 10. The backlight unit may be any backlight that applies light to the first substrate 10, such as a direct-lit backlight or an edge-lit backlight. Specific preferred examples the backlight unit include a light source unit including a light guide plate and a light source, a reflective sheet, and a diffusion sheet. The light source may be a light emitting diode (LED).

The liquid crystal display device 100 includes, as well as the components described above, components including external circuits such as a tape-carrier package (TCP) and a printed circuit board (PCB); optical films such as a viewing angle-increasing film and a luminance-increasing film; and a bezel (frame). Some components may be incorporated into other components. Description for components other than the described components is omitted because they are not limited and may be those typically used in the field of liquid crystal display devices.

### Embodiment 2

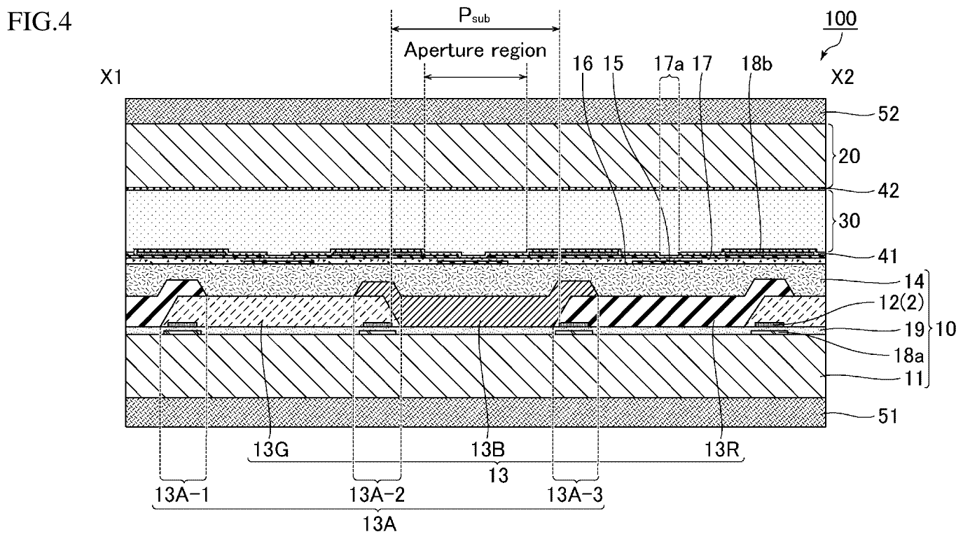

FIG. 4 is a schematic cross-sectional view of an example of a liquid crystal display device of Embodiment 2. A schematic plan view of the liquid crystal display device of Embodiment 2 is similar to that shown in FIG. 2, and the description thereof is not given. FIG. 4 corresponds to a cross-sectional view that is taken along the line X1-X2 in FIG. 2 (cross-sectional view taken along the line X1-X2). The liquid crystal display device of Embodiment 2 is similar to that of Embodiment 1 except that the first light-shielding members are disposed in a layer separate from the conductive line layer 12. Thus, the description of overlapped points is not given.

As shown in FIG. 4, in the liquid crystal display device 100 of Embodiment 2, the first light-shielding members 18a are disposed between the support substrate 11 and the conductive line layer 12. Here, when the nonlinear elements 6 are exposed to strong light, the OFF-state characteristics of the nonlinear elements 6 may deteriorate. Therefore, Embodiment 2 is suitable for the case where it is necessary to shield the lower side (the support substrate 11 side) of the conductive line layer 12 from light in order to maintain the characteristics of the nonlinear elements 6. Furthermore, compared to Embodiment 1, Embodiment 2 offers greater flexibility in designing an active matrix liquid crystal display in terms of, for example, the capacitance between the source lines and the pixel electrodes, allowing for relatively flexible design of the shape and the thickness of the first light-shielding members 18a, for example.

The first light-shielding members 18a are preferably made of a light-shielding metal, and examples thereof include metal films containing a metal such as titanium (Ti), molybdenum (Mo), aluminum (Al), or molybdenum tungsten (MoW) and multilayer films of any of these. From the viewpoint of heat resistance, the first light-shielding members 18a are preferably made of metal.

As shown in FIG. 4, the first light-shielding members 18a may be arranged on the support substrate 11, the insulating layer 19 may be formed on the first light-shielding members 18a, and the conductive line layer 12 may be formed on the insulating layer 19. The insulating layer 19 can be the same as the insulating layer 16.

Preferably, each of the conductive lines included in the conductive line layer 12 overlaps at least a portion of the corresponding overlapping portion 13A and at least a portion of the corresponding first light-shielding member 18a in a plan view. For example, each of the conductive lines such as the source lines 2 extending in the second direction D2 overlaps at least a portion of the corresponding overlapping portion 13A and at least a portion of the corresponding first light-shielding member 18a in a plan view. The first light-shielding members 18a each preferably extend along the second direction D2 with a constant width.

The width in the first direction D1 of the first light-shielding member 18a may be greater or smaller than the width in the first direction D1 of the corresponding conductive line included in the conductive line layer 12 and extending in the second direction D2. Preferably, the width in the first direction D1 of the first light-shielding member 18a is smaller than the width in the first direction D1 of the corresponding second light-shielding member 18b and the width in the first direction D1 of the corresponding overlapping portion 13A.

The liquid crystal display devices 100 of Embodiments 1 and 2 are each preferably a high-resolution liquid crystal display device having a resolution of 1000 ppi or higher. The resolution may be 1200 ppi or higher. The liquid crystal display devices 100 of Embodiments 1 and 2 can also be used as a head mounted display (HMD). Another embodiment of the present disclosure may relate to a head-mounted display including the liquid crystal display devices 100 of Embodiments 1 or 2.

### EXAMPLES

Hereinafter, the present invention is described based on examples. The examples, however, are not intended to limit the present invention.

### Example 1

A liquid crystal display device of Example 1 corresponds to the liquid crystal display device of Embodiment 1 (see FIGS. 1 to 3). To produce an active matrix liquid crystal display device for an HMD with a resolution of about 1200 ppi, a first substrate 10 was produced in which each pixel included red, green, and blue subpixels, each pixel was a 21-μm square, and each of the subpixels had dimensions of 7 μm×21 μm.

On a support substrate 11 such as a glass substrate, gate lines extending in a first direction D1 and a gate insulating film covering the gate lines were formed. Then, nonlinear elements 6 (TFTs) each including a semiconductor layer 3 made of an In—Ga—Zn—O based oxide semiconductor (IGZO: indium gallium zinc oxide) or amorphous silicon (p-Si) were formed, and source lines extending in a second direction D2 intersecting the first direction D1 were formed. In Example 1, the source lines were used as first light-shielding members 18a. The source lines were made of a metal such as Mo, and each had a width Xsl₁ in the first direction D1 of 1.6 μm. The support substrate 11 included drivers such as source drivers and gate drivers formed thereon.

A color filter layer 13 including red, green, and blue color filters was formed on the source lines using a colored organic resist. The width in the first direction D1 and the thickness of each color filter was set to 8.6 μm and 1.6 μm, respectively, and adjacent color filters having different colors were overlaid to form an overlapping portion so as to have as uniform a thickness as possible.

Specifically, each color filter was formed by spin-coating a photosensitive resin containing a corresponding colorant. In Example 1, first, a photosensitive resin containing a green colorant was applied to form green color filters in a stripe pattern along the second direction D2, with each filter having a constant width. The resin of the resulting green color filters was cured by ultraviolet light or the like. Then, a photosensitive resin containing a red colorant was applied to form red color filters in a stripe pattern along the second direction D2 such that each filter had a constant width and was formed on the left side of the corresponding green color filter so as to overlap a portion of the green color filter. The resin of the resulting red color filters was cured by ultraviolet light or the like. Then, a photosensitive resin containing a bule colorant was applied to form blue color filters in a stripe pattern along the second direction D2 such that each filter had a constant width and was formed in a space between adjacent green and red color filters so as to overlap a portion of the green color filter and a portion of the red filter. The resin of the blue color filters was cured by ultraviolet light or the like. Thus, a color filter layer 13 was completed.

In an overlapping portion with an adjacent color filter of a different color, each color filter has a thickness of about half that in the aperture region of the corresponding subpixel. Thus, the flatness of the color filter layer 13 was almost ensured by a planarization film 14 with a thickness of 2 μm formed on the color filter layer 13.

In order to display in the FFS mode, pixel electrodes were formed on the planarization film 14 using ITO or the like as first electrodes 15, an insulating layer 16 made of silicon nitride or the like was formed on the pixel electrodes, and common electrodes were formed using ITO or the like as second electrodes 17. Second light-shielding members 18b each having a width Xsl₂ of 2.6 μm were formed on the common electrodes using a metal such as Mo, and a horizontal alignment film 41 was formed on the second light-shielding members 18b. The width Xp in the first direction between second light-shielding members adjacent in the first direction was set to 4.4 μm. The pixel electrodes were electrically connected to the drain electrodes of the TFTs via through holes 5.

Light-shielding members were formed on a second substrate 20 such as a glass substrate so that each light-shielding member overlaps a corresponding gate bus line in a plan view, and a horizontal alignment film 42 was further formed. The first substrate 10 and the second substrate 20 were bonded together with a liquid crystal layer 30 therebetween so that the alignment films 41 and 42 faced each other. A transmissive linearly polarizing plate was bonded to each of the surfaces of the first substrate 10 and the second substrate 20 remote from the liquid crystal layer 30 with an adhesive layer to prepare a liquid crystal panel. The liquid crystal panel was connected to a drive circuit board and the like and combined with a backlight unit to complete a liquid crystal display device.

In Example 1, the width in the first direction D1 of each color filter was 8.6 μm, the width Xsl₁ in the first direction D1 of each first light-shielding member 18a (source line) was 1.6 μm, the width Xsl₂ in the first direction D1 of each second light-shielding member 18b was 2.6 μm, and the width Xp in the first direction of a space between adjacent second light-shielding members in the first direction was 4.4 μm. In other words, the width in the first direction D1 of each of the color filters of a plurality of colors was greater than the sum of Xp, Xsl₁, and Xsl₂. Also, the width in the first direction D1 of each of the color filters of a plurality of colors was smaller than the sum of Xp and twice Xsl₂.

The obtained liquid crystal display device was observed from the second substrate 20 side at a polar angle of 30° from the left-right direction along the first direction. No color mixing was observed, and no decrease in transmittance was observed compared to when the device was observed from the normal direction. The transmittance is the transmittance of visible light (light having a wavelength of 380 nm or more and less than 800 nm).

The embodiments of the present invention described above may be combined as appropriate within the spirit of the present invention.

What is claimed is:

1. A liquid crystal display device sequentially comprising:
a first substrate;
a liquid crystal layer; and
a second substrate,
the first substrate sequentially including a support substrate, a conductive line layer, a color filter layer, a first electrode, an insulating layer, and a second electrode disposed so as to at least partially face the first electrode with the insulating layer therebetween,
the color filter layer including a plurality of color filters arranged along a first direction, each of the plurality of color filters having one of a plurality of colors,
two color filters adjacent in the first direction among the plurality of color filters having different colors and having at least one overlapping portion where they overlap each other,
the first substrate including at least one first light-shielding member disposed on a support substrate side relative to the color filter layer and at least one second light-shielding member disposed on a liquid crystal layer side relative to the color filter layer,
the first light-shielding member overlapping at least a portion of the overlapping portion in a plan view,
the second light-shielding member overlapping at least a portion of the overlapping portion and at least a portion of the first light-shielding member in a plan view,
a width in the first direction of the second light-shielding member being greater than a width in the first direction of the first light-shielding member, and
when the width in the first direction of the first light-shielding member is defined as Xsl₁, the width in the first direction of the second light-shielding member is defined as Xsl₂, and a width in the first direction of a space between adjacent second light-shielding members in the first direction is defined as Xp, a width in the first direction of color filters of one of the plurality of colors among the plurality of color filters being greater than the sum of Xp, Xsl₁, and Xsl₂.

2. The liquid crystal display device according to claim 1,
wherein the first light-shielding member is a conductive line included in the conductive line layer.

3. The liquid crystal display device according to claim 1,
wherein the first light-shielding member is disposed between the support substrate and the conductive line layer.

4. The liquid crystal display device according to claim 3,
wherein the conductive line layer includes a conductive line overlapping at least a portion of the overlapping portion and at least a portion of the first light-shielding member in a plan view.

5. The liquid crystal display device according to claim 1,
wherein each of the color filters extends along a second direction intersecting the first direction, and the overlapping portion, the first light-shielding member, and the second light-shielding member also extend along the second direction.

6. The liquid crystal display device according to claim 5,
wherein the overlapping portion, the first light-shielding member, and the second light-shielding member each have a width in the first direction substantially constant in the second direction.

7. The liquid crystal display device according to claim 5,
wherein the first direction is defined as a direction from a first side to a second side of the liquid crystal display device, and in a case where:
an edge of the overlapping portion closer to the first side is defined as a 1st edge, an edge of the overlapping portion closer to the second side is defined as a 2nd edge,
an edge of the first light-shielding member closer to the first side is defined as a 3rd edge, an edge of the first light-shielding member closer to the second side is defined as a 4th edge,
an edge of the second light-shielding member closer to the first side is defined as a 5th edge, and an edge of the second light-shielding member closer to the second side is defined as a 6th edge,
the 5th edge, the 1st edge, the 3rd edge, the 4th edge, the 2nd edge, and the 6th edge are arranged sequentially from the first side to the second side.

8. The liquid crystal display device according to claim 1,
wherein in the color filter layer, the at least one overlapping portion includes a plurality of overlapping portions extending along a second direction and arranged along the first direction, the second direction intersecting the first direction,
in the first substrate, the at least one first light-shielding member includes a plurality of first light-shielding members extending along the second direction and arranged along the first direction, and the at least one second light-shielding member includes a plurality of second light-shielding members extending along the second direction and arranged along the first direction, and
each of the overlapping portions overlaps at least a portion of a corresponding first light-shielding member among the plurality of first light-shielding members and at least a portion of a corresponding second light-shielding member among the plurality of second light-shielding members in a plan view.

9. The liquid crystal display device according to claim 1,
wherein a width in the first direction of each of the plurality of color filters is greater than the sum of Xp, Xsl₁, and Xsl₂.

10. The liquid crystal display device according to claim 1,
wherein a width in the first direction of each of the plurality of color filters is smaller than the sum of Xp and twice Xsl₂.

11. The liquid crystal display device according to claim 1,
wherein the second electrode includes an aperture at least partially overlapping the first electrode in a plan view.

12. The liquid crystal display device according to claim 1,
wherein the first substrate includes a nonlinear element electrically connected to a conductive line included in the conductive line layer,
the first electrode is a pixel electrode and the second electrode is a common electrode, and
the pixel electrode is electrically connected to the nonlinear element via a through hole penetrating at least the color filter layer.

13. The liquid crystal display device according to claim 1,
wherein the first substrate includes a nonlinear element electrically connected to a conductive line included in the conductive line layer,
the first electrode is a common electrode and the second electrode is a pixel electrode, and
the pixel electrode is electrically connected to the nonlinear element via a through hole penetrating at least the insulating layer and the color filter layer.

14. The liquid crystal display device according to claim 1,
wherein the second substrate does not include a light-shielding member at a position facing the overlapping portion in a display region where an image is displayed.

15. The liquid crystal display device according to claim 1, further comprising:
a first polarizing plate on a surface of the first substrate remote from the liquid crystal layer; and
a second polarizing plate on a surface of the second substrate remote from the liquid crystal layer,
wherein at least one of the first polarizing plate or the second polarizing plate has an absorption peak in a wavelength range of 580 nm or more and 590 nm or less.
